(19) United States
(12) Patent Application Publication
(10) Pub. No.: US 2024/0203183 A1
(43) Pub. Date: Jun. 20, 2024

(54) METHOD FOR ACCESS MANAGEMENT TO A SECURED AREA

(71) Applicant: NINE ENGINEERING BV, Gent (BE)

(72) Inventors: Frederik Karel Julia KEYSERS, Gent (BE); Roy JEUNEN, Antwerpen (BE)

(21) Appl. No.: 18/555,614

(22) PCT Filed: Apr. 15, 2022
(86) PCT No.: PCT/IB2022/053562

§ 371 Date: Oct. 16, 2023

(30) Foreign Application Priority Data
Apr. 16, 2021 (BE) 2021/5302

(51) Int. Cl. G07C 9/25; G07C 9/27

(52) U.S. Cl. CPC G07C 9/25; G07C 9/27

(57) ABSTRACT

A method for access management to a secured area includes: receiving an invitation request comprising an electronic address of an invitee and access parameters; generating a registration request comprising a unique key based on the invitation request; transmitting the registration request to the electronic address; receiving an enrolment request from a communication device comprising the unique key; transmitting an identification request for biographical identification and biometric identification to the communication device; receiving the biographical and biometric identification; generating a proof of authentication for access to the secured area based on the access parameters; transmitting the proof of authentication to the communication device; receiving an access request that includes the proof of authentication and a biometric verification, from an access module that controls access to the secured area; verifying the proof of authentication and the biometric verification; and generating an authorization command or access to the secured area by the invitee.

### FIELD OF THE INVENTION

The present invention relates to electronic access management systems with biometric access control.

### BACKGROUND OF THE INVENTION

In electronic access management, access is granted or denied to a visitor of a secured area, e.g. a property, a building or a room. Access control can be used to provide security, keep a log of visitors, find out the number of visitors in case of an emergency, or deny visitors free access to rooms with classified information.

In electronic access management systems, a traditional key is replaced by a proof of access, e.g. an electronic access card or an electronic key fob. Upon presenting the proof of access to a reader, typically set up at the entrance to the secured area, an identification code, ID, is read that is linked to the proof of access. The ID is then compared to a database of authorized IDs. Access to the secured area is only granted if the ID matches one of the authorized IDs in the database.

Although such systems are more flexible than a classic mechanical lock, the proof of access can still be relatively easily copied, stolen, or used by an unauthorized person. Furthermore, a visitor may lose such proof of access relatively undetected.

To avoid this, multi-factor authentication can be used. Herein, in addition to providing the proof of access, the visitor must provide proof of identity to verify that he is the rightful owner of the proof of access. While the proof of access is typically an attribute that the visitor possesses, the proof of identity may be an attribute that the visitor knows, such as a pin code or a password, or a unique physical attribute of the visitor, such as a fingerprint or facial features.

Authentication based on a unique physical attribute of the visitor is usually referred to as biometric authentication. The advantage is that a visitor cannot lose or forget his proof of access as with an electronic access card. In addition, it is more difficult to falsify unique physical attributes, which makes biometric authentication more secured compared to an access card or code.

However, a problem of existing biometric authentication systems is that registering of the unique physical attributes must be done on site. This means that a visitor must physically travel to the administrator of the secured area, e.g. a reception or security department of an access control company, where the necessary unique physical attributes of the visitor are registered.

An additional challenge of existing biometric authentication systems is spoofing, wherein a forgery of a unique body feature is used to gain unauthorized access to the secured area.

### SUMMARY OF THE INVENTION

The object of the present invention is to solve the above problem by providing a solution for access management to a secured area, wherein biographical and biometric identification can be performed autonomously and remotely.

According to a first aspect, the invention relates to a method for access management to a secured area, the method comprising the following steps:
receiving an invitation request, comprising an electronic address of an invitee and access parameters; wherein the access parameters include a required biographical identification and a required biometric identification;
generating a registration request that includes a unique key based on the invitation request;
transmitting the registration request to the electronic address;
receiving an enrolment request that includes the unique key when the registration request is accepted by a communication device;
transmitting an identification request for biographical identification and for biometric identification to the communication device;
receiving biographical and biometric identification;
verifying the authenticity and correctness of the received biographical and biometric identification (119);
if the received biographical and biometric identification are authentic and correct, generating a proof of authentication for access to the secured area based on the access parameters;
transmitting the proof of authentication to the communication device;
receiving an access request that includes the proof of authentication and a biometric verification, from an access module that controls access to the secured area;
verifying the access request by comparing the proof of authentication and the biometric verification with the biographical and biometric identification; and
generating an authorization command for access to the secured area by the invitee.

Based on an electronic address and access parameters included in an invitation request received by an authentication server, a registration request is sent to an invitee's electronic address. When the invitee accepts the registration request by means of a communication device, the authentication server receives an enrolment request. The enrolment request is linked to the invitation request by a unique key, i.e. the authentication server can link each subsequent message coming from the invitee to the invitation request thanks to the unique key. An identification request is then sent to the invitee's communication device to proceed to biographical and biometric identification, required to gain access to the secured area. The biographical identification includes the personal data of the invitee, i.e. the information describing his identity. The biometric identification includes the unique physical attributes of the invitee, i.e., his measurable physical characteristics. The biometric identification can be, for example, a facial feature, an iris scan, or a fingerprint. The required biographical identification and biometric identification is included in the access parameters. In other words, the minimum required biographical and biometric identification to be granted access to the secured area is determined by the access parameters when creating the invitation request. If the received identification is complete and correct, a proof of authentication for access to the secured area is generated and sent to the invitee's communication device. This makes the access control more secured as the received identification is verified before providing the proof of authentication, i.e., after registering the invitee.

The invitee then requests access to the secured area by presenting the proof of authentication to an access module, set up near the access to the secured area, which reads the presented authentication proof and performs a biometric measurement on the person presenting the proof of authentication. The authentication server receives an access request, generated by the access module, which includes the proof of authentication and a biometric verification. After verifying the access request, i.e. comparing the presented proof of authentication and the biometric verification with the registered biographical and biometric identification, an authorization command for access to the secured area is generated.

It is an advantage that this avoids granting unauthorized access to an imposter who registers by intercepting the invitee's invitation request. It is an advantage that the invitee does not physically travel to an administrator of the secured area to register or to pick up a proof of authentication. On the one hand, because both biographical identification and biometric identification are registered autonomously and remotely by means of a communication device. On the other hand, because the proof of authentication can be sent directly to the communication device. Automating the registration, authentication, and verification make the access management more efficient. The access management is further more secured as there is less risk of the proof of authentication being lost or stolen, since relatively more attention is paid to a communication device than to, for example, an access card.

According to an embodiment, the access parameters comprise at least one of a start time, a duration, an end time, a date, a location of the secured area and an electronic address of a sender of the invitation request. As such, the access parameters determine when an invitee has access to a particular secured area, i.e., the access rights.

According to an embodiment, the proof of authentication comprises at least one of a pin code, a password, a radio-frequency identification tag, RFID, -tag, a quick response code, QR, -code, a near-field communication tag, NFC, -tag, or a bluetooth low energy tag, BLE, -tag.

According to an embodiment, the method further comprises transmitting the authorization command to the access module configured to grant the invitee access to the secured area. The generated authorization command, after verifying the access request, is sent to the access module. The access module then grants access to the secured area, for example by unlocking a gate.

According to an embodiment, the method further comprises receiving an access confirmation when access to the secured area is granted; and transmitting the access confirmation to a sender of the invitation request. In other words, when the invitee is granted access to the secured area, the access module sends a notification to the authentication server confirming the access. This is then sent to the sender of the invitation request. In this way the sender is informed that access has been granted.

According to an embodiment, the method further comprises verifying whether the electronic address of the invitee is linked to a user profile; and transmitting an identification request to the communication device based on biographical and/or biometric identification that is missing in the user profile; and completing the user profile with the biographical and/or biometric identification. The verifying of the electronic address is performed following the receipt of an invitation request. If the electronic address of the invitee is already known by the authentication server, the linked user profile and the corresponding identification are retrieved for comparison with the access parameters. If identification is missing, it is requested by sending an additional identification request. After receiving the missing biographical and/or biometric identification, these are added to the user profile for completion. In this way, the invitee needs to register a particular identification only once.

According to an embodiment, the method further comprises transmitting a notification to the communication device when the invitee is within the secured area. In doing so the invitee can, for example, be notified of security risks or receive instructions when inside the secured area.

According to an embodiment, the method further comprises monitoring a location of the invitee based on the communication device when the invitee is within the secured area. This can be done, for example, by periodically receiving global navigation satellite system, GNSS, data from the communication device or by means of a BLE beacon. The monitoring of the invitee's location can be used in cooperation with the sending of notifications as a navigation system to guide the invitee within the secured area.

According to an embodiment, the verifying further comprises verifying that the biometric verification is performed on a physical person. This can, for example, prevent spoofing where a forgery of a physical attribute of the invitee is used to gain unauthorized access to the secured area.

According to an embodiment, the unique key comprises at least one of a uniform resource locator, URL, a uniform resource identifier, URI, a token, a universally unique identifier, UUID, and a hash code. According to an embodiment, the communication device comprises at least one of a laptop, a desktop, a smartphone, a smartwatch, and a tablet.

According to a second aspect, a data processing system is provided configured to perform the method according to the first aspect.

According to a third aspect, a computer program product is provided comprising instructions executable on a computer which, when the program is executed on a computer, cause the computer to perform the method according to the first aspect.

According to a fourth aspect, a computer-readable storage medium is provided comprising the computer program product according to the third aspect.

### BRIEF DESCRIPTION OF THE DRAWINGS

FIG. 1 shows a sequence diagram showing the digital communication between devices for access management to a secured area according to an embodiment;

FIG. 2 shows the interactions during a biographical and a biometric identification based on an invitation request according to an embodiment;

FIG. 3 shows steps performed for verifying whether an invitee is already registered according to an embodiment;

FIG. 4 shows the interactions in requesting access to a secured area based on an authentication proof and a biometric verification according to an embodiment; and

FIG. 5 shows the interactions in monitoring the location of an invitee within a secured area based on a communication device according to an embodiment; and

FIG. 6 shows a control unit suitable for performing different methods according to one of the embodiments.

### DETAILED DESCRIPTION OF EMBODIMENT(S)

Embodiments according to the present invention relate to access management to a secured area. Access management may relate, for example, to granting a customer temporary access to a company for a meeting, to granting a visitor temporary access to a company for a company visit, to granting a technician temporary access to a company to perform maintenance or to granting an employee temporary access to a company to work a shift. In these examples, the secured area is always the company to which a person, i.e. the invitee, is granted access. The secured area can also be, for example, a logistics area, a port, or a depot wherein access management refers, for example, to granting access to a truck driver to pick up or deliver goods.

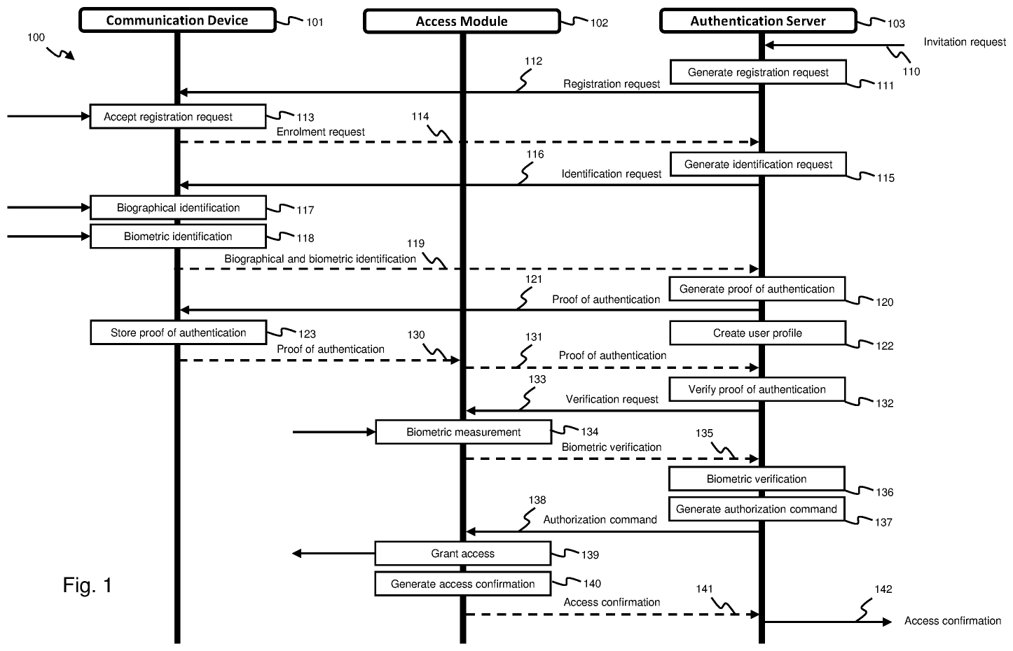

FIG. 1 shows a sequence diagram 100 with steps performed by devices 101, 102, 103 and with messages exchanged between these devices for access management to a secured area according to an embodiment. In a first step 110, an authentication server 103 receives an invitation request, i.e. an instruction from an authorized sender to the authentication server 103 to invite an invitee. To this end, the invitation request includes an electronic address of the invitee and access parameters.

The electronic address allows communication with a communication device 101 of the user and thus with the user himself. The electronic address may include, for example, an email address, a telephone number, or a user identification. Such a user identification allows to contact the invitee through a communication application such as a chat application.

The access parameters include conditions for access to the secured area such as, for example, the location of the secured area to which the invitee is granted access. Additional access parameters may be, for example, a start time, a duration, an end time, or a date on which the secured area is accessible to the invitee. The invitation request can be created by an authorized person, i.e. the sender of the request, on the authentication server itself, for example through a web application. The invitation request can also be created by a different application which then forwards it to the authentication server. Upon creating the invitation request, the sender can then enter or select the electronic address and access parameters. The electronic address of the authorized sender may further be included in the transmitted access parameters.

During the next step 111, the authentication server 103 generates a registration request based on the invitation request and sends or transmits 112 the request to the electronic address of the invitee. This sending 112 may be, for example, via an email, an SMS, an instant message, or via an application such as a web application or a mobile application. The authentication server 103 also generates a unique key associated with the invitation request to recognize the invitee's response. The authentication server may generate the key by, for example, converting the electronic address and access parameters of the invitee to a unique code using a hash function or a universally unique identifier, UUID, encoding. The unique code by itself can serve as the unique key when the authentication server 103 communicates with the invitee via a mobile application or web application. Alternatively, the unique code can be added to the pathname or query string of a uniform resource locator, URL, or uniform resource identifier, URI, to form the unique key. The authentication server then sends the URL or URI to the invitee via, for example, an e-mail, an SMS, or an instant message.

The registration request 113 is subsequently received by the communication device 101 of the invitee based on the electronic address. The communication device may for example receive the request by means of a mail user agent, a mobile application, or a web application. The communication device may, for example, be a laptop, a desktop, a smartphone, a smartwatch, or a tablet. Thereafter, the communication device 101 accepts the registration request in step 113, e.g., by receiving an instruction from the user and thus the invitee. To accept the registration request 113, the communication device 101 sends an enrolment request 114 to the authentication server 103. This enrolment request 114 includes the unique key from the registration request. The authentication server 103 then receives the enrolment request containing the unique key. By means of the unique key, the authentication server 103 relates the enrolment request to the registration request. In this way, the authentication server 103 recognizes the invitee and can link each subsequent message to the correct invitation request. In other words, the unique key allows the authentication server 103 to link each received message to the correct access parameters. In a next step 115 the authentication server 103 generates an identification request based on the unique key and based on the access parameters. Next, the server 103 sends 116 the identification request to the communication device 101 of the invitee including a request for biographical 117 and biometric 118 identification.

The biographical identification 117 includes the personal data of the invitee, i.e. the information that describes his identity such as, for example, a name, a date of birth, an address, a national register number, an identity card number, a passport number or a driver's license number. Furthermore, certificates, attestations, certificates of experience, or vehicle license plates may also be included in the biographical identification. For example, knowledge of the security regulations within the secured area may be tested during identification by means of an interview, wherein a positive evaluation results in a required attestation or certificate.

The biometric identification 118 includes the unique physical attributes of the invitee, i.e., the measurable physical characteristics such as, for example, a facial feature, a texture of an iris, a texture of a retina, a fingerprint, a finger geometry, a voice tone, a way of walking, a hand geometry, a smell, or a vein pattern.

The minimum biographical and biometric identification required to obtain access to the secured area is further defined in the access parameters. As such, the sender of the invitation request can adjust the access parameters such that, for example, a name and a portrait photograph suffice as respectively the biographical and biometric identification to obtain access to a meeting room, whereas, for example, access to a laboratory may require additional identification such as a passport number and a fingerprint.

Next, the authentication server 103 receives 119 the biographical identification 117 and biometric identification 118 captured by means of the communication device 101. The completeness of the received identification 119 can then be checked against the minimum required identification defined in the access parameters. In other words, the authentication server 103 can check for missing identification that is required to gain access to the secured area. The authentication server 103 further verifies the received identification 119 for authenticity and correctness. This may be done, for example, by checking a passport number, by checking the authenticity of a certificate, or by comparing a received facial feature with the passport photo of an electronic passport. The server 103 can further perform a liveness detection algorithm on the biometric identification 118 to prevent forgery. Such an algorithm detects whether the biometric identification 118 is performed on a physically present person or on a forged inanimate object, such as, for example, a printed photograph or a forged fingerprint.

If the identification is complete and correct, the authentication server 103 generates 120 a proof of authentication and sends 121 the proof to the communication device 101 of the invitee. This proof can then be used to later access the secured area based on the access parameters. In other words, the proof of authentication is linked to both the received identification 119 and the access parameters. For example, the proof of authentication may be a pin code, a password, a radio-frequency identification, RFID. - tag, a quick response, QR, -code, a near-field communication, NFC, -tag or a bluetooth low energy, BLE, -tag. Further, the communication device 101 may store the proof of authentication 123 until the invitee requests access to the secured area. The authentication server 103 may further create a user profile 122 to collect and store all received data linked to the invitation request, i.e., the electronic address of the invitee, the access parameters, the biographical identification, the biometric identification, the invitation request, and the proof of authentication.

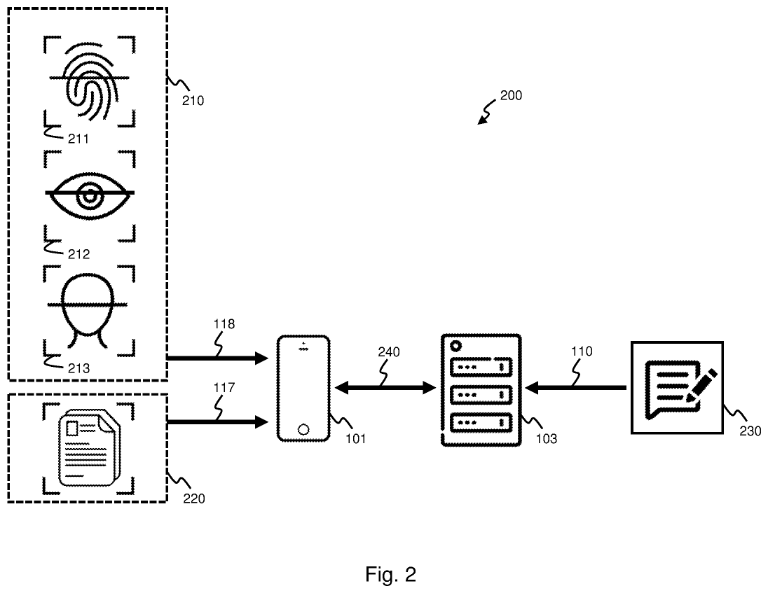

FIG. 2 illustrates the interactions between the devices 101 and 103 during the biographical identification 117 and the biometric identification 118 based on the invitation request 230 according to an embodiment. The authentication server 103 is configured to perform the steps as described according to various embodiments. The authentication server 103 is further configured to receive the invitation request. The authentication server 103 may include a combination of hardware and software required to manage access to the secured area according to various embodiments. For example, the authentication server 103 may be a virtual private server, VPS, a dedicated server, a clustered server, or a cloud server running a software program to manage access control according to various embodiments. The authentication server 103 is further equipped to communicate with the communication device 101 of the invitee by means of, for example, an email, an SMS, an iCalendar invitation, an instant message, a mobile application, a web application, or another specific application. The communication device 101 can thus receive the identification request 230 and register biographical 117 and the biometric identification 118. Thus, the invitee can perform the identification 117, 118 autonomously and remotely from the secured area without physically traveling to the area.

According to the embodiment 200 illustrated in FIG. 2, the communication device 101 may be, for example, a smartphone by which unique physical attributes 210 of the invitee may be measured for biometric identification 118. To this end, the communication device 101 includes, for example, a camera or a 3-D sensor to record a facial feature 213; an infrared, IR, sensor or near-infrared, NIR, sensor to record the texture of the iris 212; or an optical sensor, a capacitive sensor, or an ultrasonic sensor to record a fingerprint 211. Further, the communication device 101 can be easily used to provide the personal data 220 of the invitee for biographical identification 117 by means of a keyboard, an on-screen keyboard, or by uploading digital documents. Furthermore, physical documents for biographical identification 117 may also be scanned by means of a camera provided in the communication device 101. The communication device 101 is provided 240 to communicate both the biographical 117 and biometric 118 identification with the authentication server 103.

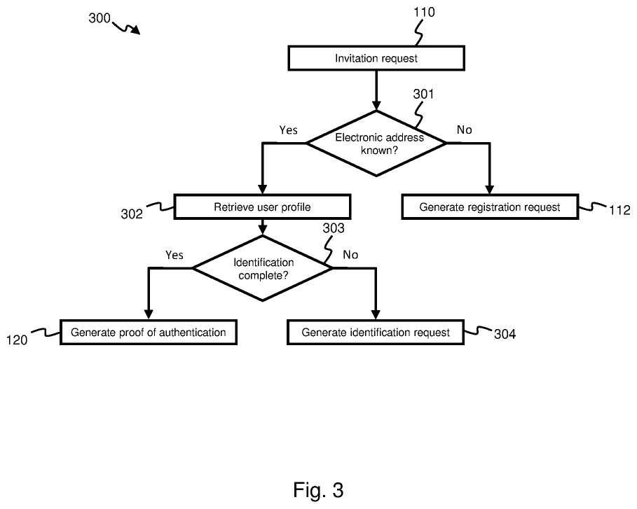

FIG. 3 illustrates steps of a method 300 that the authentication server 103 may perform to verify that an invitee is already registered. For example, this method may be performed after receiving invitation request 110. In a first step 301, the authentication server 103 checks whether the electronic address of the invitee is linked to an existing and stored user profile. If this is not the case, then the server 103 generates a registration request 112 as described above in the sequence diagram 100. If the electronic address does belong to an already existing user profile, then the server 302 retrieves the user profile data. In particular, the stored biometric and biographical identification is retrieved to compare 303 with the minimum required identification to be granted access to the secured area, defined in the access parameters of the invitation request. If the identification is found to be complete, then the proof of authentication can be generated 120 immediately based on the new invitation request. If the identification is incomplete or inadequate, then the method may proceed to generate 304 an identification request. This request differs from the identification request 116 described above in that the sequence diagram 100 only asks for the missing biographical or biometric identification to be provided. Upon receiving this missing identification, the authentication server 103 can complete the existing user profile with it. In this way, it can be avoided that the invitee has to provide all the identification again with each new invitation, thus the invitee has to perform each identification only once.

Once the invitee is registered and possesses a proof of authentication, i.e., after step 121, he may gain access to the secured area by presenting the proof of authentication 130 to an access module 102. The access module 102 may be set up in the vicinity of the access to the secured area. The module 102 reads the information included in the presented proof of authentication. To this end, the access module 102 may be configured to read one or more types of proofs of authentication by means of, for example, an RFID reader, a numeric keypad, an image sensor, or a BLE reader. The access module 102 then sends the read information to the authentication server 103 which can then verify the proof of authentication 132, i.e., checking the access parameters such as, for example, the time at which the invitee requests access or the area to which the invitee requests access.

The authentication server 103 responds to a valid proof of authentication by sending a verification request 133 to the access module 102. This request is an instruction to perform a biometric measurement 134 on the invitee. The biometric measurement 134 includes measuring one or more unique physical attributes of the invitee, i.e., the measurable physical characteristics such as, for example, a facial feature, an iris scan, a retina scan, a fingerprint, a finger geometry, a voice tone, a way of walking, a hand geometry, a smell, or a vein pattern. The access module 102 may further be configured to perform one or more of the possible biometric measurements 134 by means of, for example, a camera, a 3D sensor, an infrared sensor, an NIR sensor, an optical sensor, a capacitive sensor, an ultrasonic sensor, an iris scanner, or a fingerprint scanner.

The access module 102 then sends 135 the biometric measurement 134 to the authentication server 103 for biometric verification 136, i.e., comparing the biometric measurement 134 with the biometric identification 118 linked to the proof of authentication. To prevent falsification of the biometric measurement, the server 103 may further perform a liveness detection algorithm. Such an algorithm detects whether the biometric measurement 134 is performed on a physically present person or on a forged inanimate object, such as, for example, a printed photograph of the invitee, a mask, or a forged fingerprint. If the biometric verification 136 is successful, i.e., if the biometric measurement 134 matches the biometric identification 118 and was performed on a physically present person, the authentication server generates 137 an authorization command for access to the secured area. In other words, in the case of a successful biometric verification 136, the server 103 generates 137 a command to unlock the secured area and thus grant the invitee access to the secured area.

To this end, the authentication server 103 may further transmit the authorization command 138 to the access module 102. For example, the module 102 may control an electronic lock that locks access to the secured area. Such a lock may include, for example, a magnet, a solenoid, or a motor to control the opening and closing of the lock based on an electrical control signal, i.e., the authorization command 138. When the access module 102 unlocks the electronic lock, the module may generate an access confirmation 140 and further transmit 141 it to the authentication server 103. The server 103 may then further deliver 142 the access confirmation to the electronic address of the sender of the invitation request to notify that the invitee has entered the secured area, for example, by means of an email, an SMS, an instant message, a mobile app, a web application, or an application.

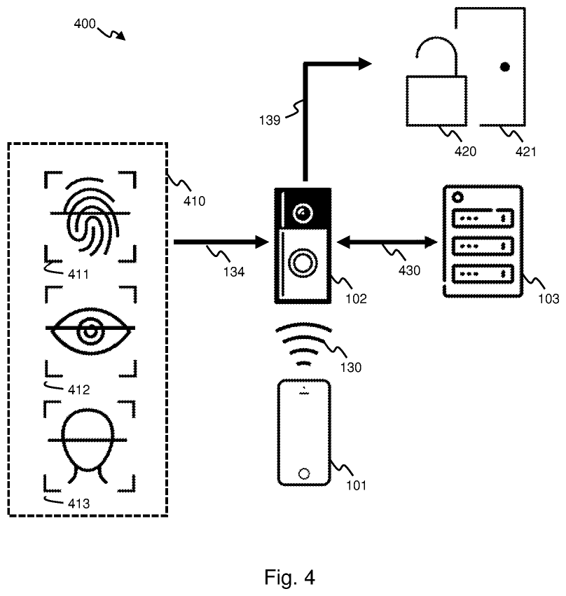

FIG. 4 illustrates the interactions when requesting access to a secured area based on an access request, i.e., presenting a proof of authentication 130 and a biometric verification 135. In embodiment 400, the invitee presents a proof of authentication, stored on a communication device 101, to an access module 102 that is deployed in the vicinity of an access 421 to the secured area. Depending on the type of proof of authentication, reading of the proof of authentication 130 may be done without contact with the access module 102, for example by means of an RFID reader to read an RFID tag, an image sensor to scan a QR code, an NFC reader to read an NFC tag, or a BLE reader to receive a BLE signal. The module 102 may further include a keypad or touch screen to enter, for example, a password or code as a proof of authentication. Alternatively or complementary, the module 102 may be provided with an automatic number plate recognition, ANPR, camera to read a license plate of a vehicle. The access module 102 then communicates 430 the read information to the authentication server 103 for verification 132 and receives a response based on the validity of the proof of authentication, i.e., whether the access parameters of the read proof of authentication entitle the invitee to access the secured area 421.

After successful verification 132 of the proof of authentication, the access module 102 performs a biometric measurement 134 on the invitee. To this end, the module 102 includes, for example, a camera or 3D sensor to measure a facial feature 413; an infrared sensor or near-infrared, NIR, sensor to measure the texture of the iris 412; and an optical sensor, a capacitive sensor, or an ultrasonic sensor to measure a fingerprint 411. The module 102 sends the measurement 134 to the authentication server 103 for biometric verification 136, which communicates the result to the access module 102 through an authorization command 138. Based on the command, the access module 102 may control an electronic lock 420 to unlock access 421 to a secured area.

When the invitee enters the secured area, he may further receive notifications on the communication device 101, sent by the authentication server 103. Notifications include messages and notifications that the server 103 may send to the communication device 101 to inform, guide, or alert the invitee during his visit to the secured area. In doing so, the server 103 may for example send a security notification when a fire breaks out or a toxic chemical leak is detected. Alternatively or complementary, the authentication server 103 may assist the invitee in performing a task within the secured area, for example, based on received instructions, i.e., notifications.

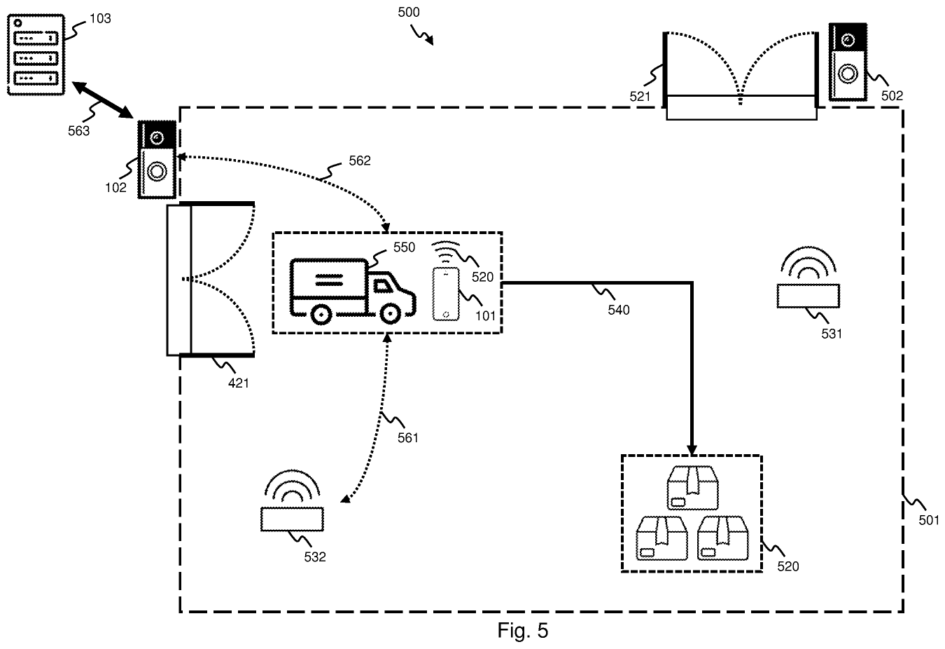

Further, the authentication server 103 may monitor the location of the invitee within the secured area based on the communication device 101. According to an embodiment 500 illustrated in FIG. 5, this may be done, for example, by periodically receiving the global navigation satellite system, GNSS, data 520 from the communication device 101 by the access module 102, which then transmits 563 the data 520 to the authentication server 103. Alternatively or complementary, the server 103 may determine and monitor the location of the communication device 101 by means of a positioning system based on beacons 531, 532. Such a positioning system may use, for example, BLE-signals, ultra-wideband, UWB-signals, WiFi-signals, or NFC-signals to determine whether the communication device 101 is in the vicinity of a beacon 531, 532. Further, one or more access modules 102, 502 within the secured area 501 may act as a beacon or be part of a network of beacons 102, 502, 531, 532.

For example, in the embodiment 500, the authentication server 103 granted access to the secured area 501 to a truck 550 operated by a truck driver. To this end, the driver has had a proof of authentication on his communication device 101 read by an access module 102, set up in the vicinity of an access 421 to the secured area 501. The communication device 101 receives the BLE-signal 561, 562 from the beacons 102, 532 that are within range, i.e., for example, one BLE beacon 532 and one access module 102 acting as a BLE beacon. The authentication server 103 receives the information included in the signals 561, 562 and can thereby determine the location of the communication device 101. Monitoring the location of the invitee, in conjunction with sending notifications, can serve as a navigation system, wherein the authentication server 103 guides the invitee to his destination within the secured area 501. As such, the server 103 may, for example, navigate 540 the truck driver 510 to the goods to be picked up 520 or navigate the truck driver to a location where the goods are to be delivered within a logistics area, a depot, or a port, i.e., the secured area 501. Alternatively or complementary, the authentication server 103 may navigate a customer to a meeting room, navigate a technician to the facility to be serviced, or tour a visitor within a secured area.

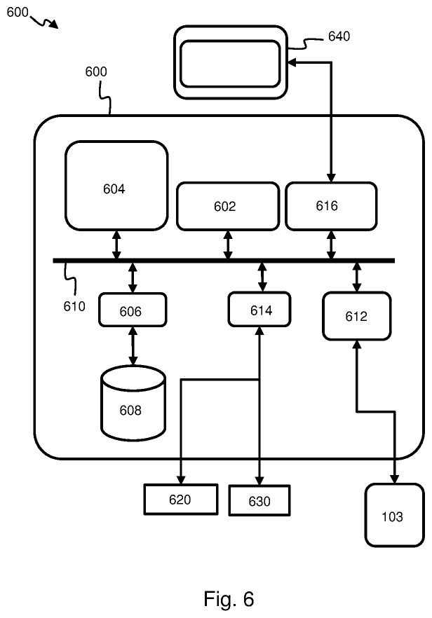

FIG. 6 shows a suitable computing system 600 enabling to implement embodiments of the above described method according to the invention. Computing system 600 may in general be formed as a suitable general-purpose computer and comprise a data bus 610, a processor 602, a local memory 604, one or more optional input interfaces 614, one or more optional output interfaces 616, a communication interface 612, a storage element interface 606, and one or more storage elements 608. Bus 610 may comprise one or more conductors that permit communication among the components of the computing system 600. Processor 602 may include any type of conventional processor or microprocessor that interprets and executes programming instructions. Local memory 604 may include a random-access memory (RAM) or another type of dynamic storage device that stores information and instructions for execution by processor 602 and/or a read only memory (ROM) or another type of static storage device that stores static information and instructions for use by processor 602. Input interface 614 may comprise one or more conventional mechanisms that permit an operator or user to input information to the computing device 600, such as a keyboard 620, a mouse 630, a pen, voice recognition and/or biometric mechanisms, a camera, etc. Output interface 616 may comprise one or more conventional mechanisms that output information to the operator or user, such as a display 640, etc. Communication interface 612 may comprise any transceiver-like mechanism such as for example one or more Ethernet interfaces that enables computing system 600 to communicate with other devices and/or systems such as for example, amongst others, the communication device 101. The communication interface 612 of computing system 600 may be connected to such another computing system by means of a local area network (LAN) or a wide area network (WAN) such as for example the internet. Storage element interface 606 may comprise a storage interface such as for example a Serial Advanced Technology Attachment (SATA) interface or a Small Computer System Interface (SCSI) for connecting bus 610 to one or more storage elements 608, such as one or more local disks, for example SATA disk drives, and control the reading and writing of data to and/or from these storage elements 608. Although the storage element(s) 608 above is/are described as a local disk, in general any other suitable computer-readable media such as a removable magnetic disk, optical storage media such as a CD or DVD, -ROM disk, solid state drives, flash memory cards, etc. could be used.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. A computer implemented method for access management to a secured area by means of an authentication server, the method comprising the following steps:
receiving an invitation request, comprising an electronic address of an invitee and access parameters;
wherein the access parameters include a required biographical identification and a required biometric identification;
generating a registration request that includes a unique key based on the invitation request;
transmitting the registration request to the electronic address;
receiving an enrolment request that includes the unique key when the registration request is accepted by a communication device;
transmitting an identification request for biographical identification and for biometric identification to the communication device;
receiving the biographical and biometric identification;
verifying the authenticity and correctness of the received biographical and biometric identification;
if the received biographical and biometric identification are authentic and correct, generating a proof of authentication for access to the secured area based on the access parameters;
transmitting the proof of authentication to the communication device;
receiving an access request that includes the proof of authentication and a biometric verification, from an access module that controls access to the secured area;
verifying the access request by comparing the proof of authentication and the biometric verification with the biographical and biometric identification; and
generating an authorization command for access to the secured area by the invitee.

17. The method according to claim 16, wherein the biometric identification comprises at least one of a facial feature, an iris scan, and a fingerprint.

18. The method according to claim 16, wherein the access parameters comprise at least one of a start time, a duration, an end time, a date, a location of the secured area, and an electronic address of a sender of the invitation request.

19. The method according to claim 16, wherein the proof of authentication comprises at least one of a pin code, a password, a radio-frequency identification, RFID, -tag, a quick response, QR, -code, a near-field communication, NFC, -tag, or a Bluetooth low energy, BLE, -tag.

20. The method according to claim 16, further comprising transmitting the authorization command to the access module to grant the invitee access to the secured area.

21. The method according to claim 16, further comprising receiving an access confirmation when access to the secured area is granted; and transmitting the access confirmation to a sender of the invitation request.

22. The method according to claim 16, further comprising verifying whether the electronic address of the invitee is linked to a user profile; and transmitting an identification request to the communication device based on biographical and/or biometric identification that is missing in the user profile; and completing the user profile with the biographical and/or biometric identification.

23. The method according to claim 16, further comprising transmitting a notification to the communication device when the invitee is within the secured area.

24. The method according to claim 16, further comprising monitoring a location of the invitee based on the communication device when the invitee is within the secured area.

25. The method according to claim 16, wherein the verifying further comprises verifying that the biometric verification is performed on a physical person.

26. The method according to claim 16, wherein the unique key comprises at least one of a uniform resource locator, URL, a uniform resource identifier, URI, a token, a hash code, and a universally unique identifier, UUID.

27. The method according to claim 16, wherein the communication device comprises at least one of a laptop, a desktop, a smartphone, a smartwatch, and a tablet.

28. A data processing system configured to perform the computer implemented method according to claim 16.

29. A computer program product comprising instructions executable on a computer which, when the program is executed on a computer, cause the computer to perform the computer implemented method according to claim 16.

30. A computer-readable storage medium comprising the computer program product according to claim 19.
